(19) United States
(12) Patent Application Publication
(10) Pub. No.: US 2023/0374384 A1
(43) Pub. Date: Nov. 23, 2023

(54) POLYMER COMPOUND, COMPOSITION, AND MOLDED PRODUCT

(71) Applicant: FUJIFILM Corporation, Tokyo (JP)

(72) Inventor: Hideyuki NISHIKAWA, Minamiashigara-shi (JP)

(73) Assignee: FUJIFILM Corporation, Tokyo (JP)

(21) Appl. No.: 18/361,621

(22) Filed: Jul. 28, 2023

Related U.S. Application Data
(63) Continuation of application No. PCT/JP2022/006825, filed on Feb. 21, 2022.

(30) Foreign Application Priority Data
Feb. 24, 2021 (JP) 2021-027733

(51) Int. Cl. C09K 19/38

(52) U.S. Cl. CPC C09K 19/3823; C09K 2219/03

(57) ABSTRACT

An object of the present invention is to provide a polymer compound with which a molded product having a low dielectric loss tangent can be obtained, a composition, and a molded product. The polymer compound of the present invention is a polymer compound exhibiting liquid crystallinity, having a repeating unit including, in the following order, a rigid part consisting of a combination of an aromatic part having a 6-membered ring and an aromatic part having a 5-membered ring, a linker part selected from Group 1, a flexible part consisting of an alkylene group having 2 or more carbon atoms, and a linker part selected from Group 1.

Group 1: a single bond or a divalent linking group selected from the group consisting of —O—, —S—, —CO—, —SO₂—, —NR—, —CH≡CH—, and a combination of these groups, where R represents a hydrogen atom or an alkyl group

### CROSS-REFERENCE TO RELATED APPLICATIONS

This application is a Continuation of PCT International Application No. PCT/JP2022/006825 filed on Feb. 21, 2022, which claims priority under 35 U.S.C. § 119(a) to Japanese Patent Application No. 2021-027733 filed on Feb. 24, 2021. The above applications are hereby expressly incorporated by reference, in their entirety, into the present application.

### BACKGROUND OF THE INVENTION

### 1. Field of the Invention

The present invention relates to a polymer compound, a composition, and a molded product.

### 2. Description of the Related Art

A liquid crystal polymer film including a polymer liquid crystal (liquid crystal polymer) has excellent electrical properties (low dielectric constant and low dielectric loss) in a high frequency range (GHz band), and has been attracted as a material for flexible printed circuit (FPC) substrate and the like because of its characteristics such as low electrical transmission loss in a circuit.

For example, JP2020-193261A discloses “liquid crystal polymer composition containing 100 parts by mass of a liquid crystal polymer and 0.1 to 20 parts by mass of a polyarylate resin, in which a melt tension is 3 mN or more, and a dielectric loss tangent measured at 1 GHz using a stick-shaped test piece with a length of 85 mm, a width of 1.75 mm, and a thickness of 1.75 mm is 0.0015 or less” ([claim 1]), and as the liquid crystal polymer, a liquid crystal polyester including a repeating unit represented by Formulae (I) to (III) [in the formulae, Ari and Are each represent one or two or more of divalent aromatic groups, and p, q, and r are each a compositional ratio (mol %) in a liquid crystal polyester (A), where the following conditions are satisfied, 35≤p≤90, 5≤q≤30, and 5≤r≤30] ([claim 3]).

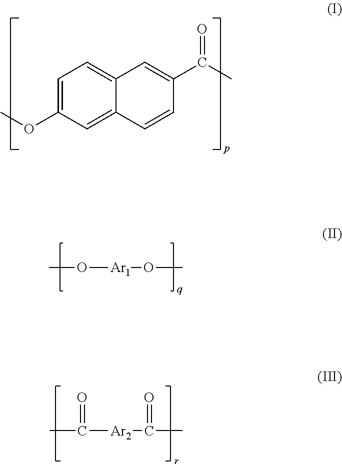

### SUMMARY OF THE INVENTION

As a result of studying on the liquid crystal polymer disclosed in JP2020-193261A, the present inventor has clarified that there is room for improvement in reducing the dielectric loss tangent of a molded product (for example, a film or the like) molded from the liquid crystal polymer.

Therefore, an object of the present invention is to provide a polymer compound with which a molded product having a low dielectric loss tangent can be obtained, a composition, and a molded product.

As a result of intensive studies to achieve the above-described objects, the present inventors have found that, by using a polymer compound having a repeating unit including a rigid part consisting of a combination of an aromatic part having a 6-membered ring and an aromatic part having a 5-membered ring, a predetermined linker part, a flexible part consisting of an alkylene group having 2 or more carbon atoms, and a predetermined linker part in this order, it is possible to obtain a molded product having a low dielectric loss tangent, and have completed the present invention.

That is, the present inventors have found that the above-described objects can be achieved by the following configuration.
[1] A polymer compound exhibiting liquid crystallinity, comprising:
a repeating unit including, in the following order,
   a rigid part consisting of a combination of an aromatic part having a 6-membered ring and an aromatic part having a 5-membered ring,
   a linker part selected from Group 1,
   a flexible part consisting of an alkylene group having 2 or more carbon atoms, and
   a linker part selected from Group 1,
Group 1: a single bond or a divalent linking group selected from the group consisting of —O—, —S—, —CO—, —SO₂—, —NR—, —CH≡CH—, and a combination of these groups, where R represents a hydrogen atom or an alkyl group,
provided that the rigid part has a structure which consists of two or more of aromatic parts having a 6-membered ring and one or more of aromatic parts having a 5-membered ring, where the two or more aromatic parts having a 6-membered ring are apart from each other, and
in the flexible part, one or more of —CH₂-'s constituting the alkylene group other than a terminal may be substituted with —O—, —S—, —CO—, —SO₂—, —NR—, —CH═CH—, or where R represents a hydrogen atom or an alkyl group.
[2] The polymer compound according to [1],
in which the aromatic part having a 6-membered ring is represented by Formula (1) or (2) described later.
[3] The polymer compound according to [1] or [2],
in which the aromatic part having a 5-membered ring is represented by Formula (3) or (4) described later.
[4] A polymer compound comprising:
a repeating unit including, in the following order,
   a rigid part consisting of a combination of an aromatic part having a 6-membered ring and an aromatic part having a 5-membered ring,
   a linker part selected from Group 1,
   a flexible part consisting of an alkylene group having 2 or more carbon atoms, and
   a linker part selected from Group 1,
in which the aromatic part having a 6-membered ring is a 1,3-phenylene group or a 1,4-phenylene group,
the aromatic part having a 5-membered ring is a 1,2,4-oxadiazole-3,5-diyl group,
Group 1: a single bond or a divalent linking group selected from the group consisting of —O—, —S—, —CO—, —SO₂—, —NR—, —CH═CH—, and a combination of these groups, where R represents a hydrogen atom or an alkyl group,
provided that the rigid part has a structure which consists of two or more of aromatic parts having a 6-membered ring and one or more of aromatic parts having a 5-membered ring, where the two or more aromatic parts having a 6-membered ring are apart from each other, and
in the flexible part, one or more of —CH₂-'s constituting the alkylene group other than a terminal may be substituted with —O—, —S—, —CO—, —SO₂—, —NR—, —CH═CH—, or where R represents a hydrogen atom or an alkyl group.
[5] A composition comprising:
the polymer compound according to any one of [1] to [4]. [6] A molded product obtained by processing the polymer compound according to any one of [1] to [4] or the composition according to [5].

According to the present invention, it is possible to provide a polymer compound with which a molded product having a low dielectric loss tangent can be obtained, a composition, and a molded product.

### DESCRIPTION OF THE PREFERRED EMBODIMENTS

Hereinafter, the present invention will be described in more detail.

The following description of configuration requirements is based on typical embodiments of the present invention, but the present invention is not limited thereto.

In the present specification, a numerical range expressed using “to” means a range including numerical values before and after “to” as a lower limit value and an upper limit value.

In addition, in the present specification, for each component, one kind of substance corresponding to each component may be used alone, or two or more kinds thereof may be used in combination. Here, in a case where two or more types of substances are used in combination for each component, the content of the component refers to a total content of the substances used in combination unless otherwise specified.

In addition, in the present specification, a bonding direction of a divalent group (for example, —O—CO—) described is not particularly limited, and for example, in a case where L² in an “L¹-L²-L³” bond is —O—CO—, and a bonding position on the L¹ side is represented by *1 and a bonding position on the L³ side is represented by *2, L² may be *1-O—CO—*2 or *1-CO—O—*2.

In addition, in the present specification, “may have a substituent” includes not only an aspect of not having a substituent but also an aspect of having one or more substituents.

Here, examples of the substituent include substituents described in the following substituent group A.

<Substituent Group A>

The substituent group A represents a halogen atom (for example, a fluorine atom, a chlorine atom, and a bromine atom; preferably a chlorine atom or a fluorine atom and more preferably a fluorine atom), an alkyl group (a linear, branched, or cyclic alkyl group having preferably 1 to 48 carbon atoms, more preferably 1 to 24 carbon atoms, and particularly preferably 1 to 8 carbon atoms; examples thereof include a methyl group, an ethyl group, a propyl group, an isopropyl group, a butyl group, a t-butyl group, a pentyl group, a hexyl group, a heptyl group, an octyl group, a 2-ethylhexyl group, a dodecyl group, a hexadecyl group, a cyclopropyl group, a cyclopentyl group, a cyclohexyl group, a 1-norbornyl group, and a 1-adamantyl group), an alkenyl group (an alkenyl group having preferably 2 to 48 carbon atoms and more preferably 2 to 18 carbon atoms; examples thereof include a vinyl group, an allyl group, and a 3-buten-1-yl group), an aryl group (an aryl group having preferably 6 to 48 carbon atoms and more preferably 6 to 24 carbon atoms; examples thereof include a phenyl group and a naphthyl group), a heterocyclic group (a heterocyclic group having preferably 1 to 32 carbon atoms and more preferably 1 to 18 carbon atoms; examples thereof include a 2-thienyl group, a 4-pyridyl group, a 2-furyl group, a 2-pyrimidinyl group, a 1-pyridyl group, a 2-benzothiazolyl group, a 1-imidazolyl group, a 1-pyrazolyl group, and a benzotriazol-1-yl group), a silyl group (a silyl group having preferably 3 to 38 carbon atoms and more preferably 3 to 18 carbon atoms; examples thereof include a trimethylsilyl group, a triethylsilyl group, a tributylsilyl group, a t-butyldimethylsilyl group, and a t-hexyldimethylsilyl group), a hydroxy group, a cyano group, a nitro group, an alkoxy group (an alkoxy group having preferably 1 to 48 carbon atoms and more preferably 1 to 24 carbon atoms; examples thereof include a methoxy group, an ethoxy group, a 1-butoxy group, a 2-butoxy group, an isopropoxy group, a t-butoxy group, a dodecyloxy group, and cycloalkyloxy groups such as a cyclopentyloxy group and a cyclohexyloxy group), an aryloxy group (an aryloxy group having preferably 6 to 48 carbon atoms and more preferably 6 to 24 carbon atoms; examples thereof include a phenoxy group and a 1-naphthoxy group), a heterocyclic oxy group (a heterocyclic oxy group having preferably 1 to 32 carbon atoms and more preferably 1 to 18 carbon atoms; examples thereof include a 1-phenyltetrazol-5-oxy group and a 2-tetrahydropyranyloxy group), a silyloxy group (a silyloxy group having preferably 1 to 32 carbon atoms and more preferably 1 to 18 carbon atoms; examples thereof include a trimethylsilyloxy group, a t-butyldimethylsilyloxy group, and a diphenylmethylsilyloxy group), an acyloxy group (an acyloxy group having preferably 2 to 48 carbon atoms and more preferably 2 to 24 carbon atoms; examples thereof include an acetoxy group, a pivaloyloxy group, a benzoyloxy group, and a dodecanoyloxy group), an alkoxycarbonyloxy group (an alkoxycarbonyloxy group having preferably 2 to 48 carbon atoms and more preferably 2 to 24 carbon atoms; examples thereof include an ethoxycarbonyloxy group, a t-butoxycarbonyloxy group, and cycloalkyloxycarbonyloxy groups such as a cyclohexyloxycarbonyloxy group), an aryloxycarbonyloxy group (an aryloxycarbonyloxy group having preferably 7 to 32 carbon atoms and more preferably 7 to 24 carbon atoms; examples thereof include a phenoxycarbonyloxy group), a carbamoyloxy group (a carbamoyloxy group having preferably 1 to 48 carbon atoms and more preferably 1 to 24 carbon atoms; examples thereof include an N,N-dimethylcarbamoyloxy group, an N-butylcarbamoyl oxy group, an N-phenylcarbamoyloxy group, and an N-ethyl-N-phenylcarbamoyloxy group), a sulfamoyloxy group (a sulfamoyloxy group having preferably 1 to 32 carbon atoms and more preferably 1 to 24 carbon atoms; examples thereof include an N,N-diethylsulfamoyloxy group and an N-propylsulfamoyloxy group), an alkylsulfonyloxy group (an alkylsulfonyloxy group having preferably 1 to 38 carbon atoms and more preferably 1 to 24 carbon atoms; examples thereof include a methylsulfonyloxy group, a hexadecylsulfonyloxy group, and a cyclohexylsulfonyloxy group), an arylsulfonyloxy group (an arylsulfonyloxy group having preferably 6 to 32 carbon atoms and more preferably 6 to 24 carbon atoms; examples thereof include a phenylsulfonyloxy group), an acyl group (an acyl group having preferably 1 to 48 carbon atoms and more preferably 1 to 24 carbon atoms; examples thereof include a formyl group, an acetyl group, a pivaloyl group, a benzoyl group, a tetradecanoyl group, and a cyclohexanoyl group), an alkoxycarbonyl group (an alkoxycarbonyl group having preferably 2 to 48 carbon atoms and more preferably 2 to 24 carbon atoms; examples thereof include a methoxycarbonyl group, an ethoxycarbonyl group, an octadecyloxycarbonyl group, a cyclohexyloxycarbonyl group, and a 2,6-di-tert-butyl-4-methylcyclohexyloxycarbonyl group), an aryloxycarbonyl group (an aryloxycarbonyl group having preferably 7 to 32 carbon atoms and more preferably 7 to 24 carbon atoms; examples thereof include a phenoxycarbonyl group), a carbamoyl group (a carbamoyl group having preferably 1 to 48 carbon atoms and more preferably 1 to 24 carbon atoms; examples thereof include a carbamoyl group, an N,N-diethylcarbamoyl group, an N-ethyl-N-octylcarbamoyl group, an N,N-dibutylcarbamoyl group, an N-propylcarbamoyl group, an N-phenylcarbamoyl group, an N-methyl-N-phenylcarbamoyl group, and an N,N-dicyclohexylcarbamoyl group), an amino group (an amino group having preferably 32 or less carbon atoms and more preferably 24 or less carbon atoms; examples thereof include amino, a methylamino group, an N,N-dibutylamino group, a tetradecylamino group, a 2-ethylhexylamino group, and a cyclohexylamino group), an anilino group (an anilino group preferably having 6 to 32 carbon atoms and more preferably 6 to 24 carbon atoms; examples thereof include an anilino group and an N-methylanilino group), a heterocyclic amino group (a heterocyclic amino group having preferably 1 to 32 carbon atoms and more preferably 1 to 18 carbon atoms; examples thereof include a 4-pyridylamino group), a carbonamide group (a carbonamide group having preferably 2 to 48 carbon atoms and more preferably 2 to 24 carbon atoms; examples thereof include an acetamide group, a benzamide group, a tetradecanamide group, a pivaloylamide group, and a cyclohexanamide group), a ureido group (a ureido group having preferably 1 to 32 carbon atoms and more preferably 1 to 24 carbon atoms; examples thereof include a ureido group, an N,N-dimethylureido group, and an N-phenylureido group), an imide group (an imide group having 36 or less carbon atoms and more preferably 24 or less carbon atoms; examples thereof include an N-succinimide group and an N-phthalimide group), an alkoxycarbonylamino group (an alkoxycarbonylamino group having preferably 2 to 48 carbon atoms and more preferably 2 to 24 carbon atoms; examples thereof include a methoxycarbonylamino group, an ethoxycarbonylamino group, a t-butoxycarbonylamino group, an octadecyloxycarbonylamino group, and a cyclohexyloxycarbonylamino group), an aryloxycarbonylamino group (an aryloxycarbonylamino group having preferably 7 to 32 carbon atoms and more preferably 7 to 24 carbon atoms; examples thereof include a phenoxycarbonylamino group), a sulfonamide group (a sulfonamide group having preferably 1 to 48 carbon atoms and more preferably 1 to 24 carbon atoms; examples thereof include a methanesulfonamide group, a butanesulfonamide group, a benzenesulfonamide group, a hexadecanesulfonamide group, and a cyclohexanesulfoneamide group), a sulfamoylamino group (a sulfamoylamino group having preferably 1 to 48 carbon atoms and more preferably 1 to 24 carbon atoms; examples thereof include an N,N-dipropylsulfamoylamino group and an N-ethyl-N-dodecyl sulfamoylamino group), an azo group (an azo group having preferably 1 to 32 carbon atoms and more preferably 1 to 24 carbon atoms; examples thereof include a phenylazo group and a 3-pyrazolyl azo group), an alkylthio group (an alkylthio group having preferably 1 to 48 carbon atoms and more preferably 1 to 24 carbon atoms; examples thereof include a methylthio group, an ethylthio group, an octylthio group, and a cyclohexylthio group), an arylthio group (an arylthio group having preferably 6 to 48 carbon atoms and more preferably 6 to 24 carbon atoms; examples thereof include a phenylthio group), a heterocyclic thio group (a heterocyclic thio group having preferably 1 to 32 carbon atoms and more preferably 1 to 18 carbon atoms; examples thereof include a 2-benzothiazolylthio group, a 2-pyridylthio group, and a 1-phenyltetrazolylthio group), an alkylsulfinyl group (an alkylsulfinyl group having preferably 1 to 32 carbon atoms and more preferably 1 to 24 carbon atoms; examples thereof include a dodecanesulfinyl group), an arylsulfinyl group (an arylsulfinyl group having preferably 6 to 32 carbon atoms and more preferably 6 to 24 carbon atoms; examples thereof include a phenylsulfinyl group), an alkylsulfonyl group (an alkylsulfonyl group having preferably 1 to 48 carbon atoms and more preferably 1 to 24 carbon atoms; examples thereof include a methylsulfonyl group, an ethylsulfonyl group, a propylsulfonyl group, a butylsulfonyl group, an isopropylsulfonyl group, a 2-ethylhexylsulfonyl group, a hexadecylsulfonyl group, an octylsulfonyl group, and a cyclohexylsulfonyl group), an arylsulfonyl group (an arylsulfonyl group having preferably 6 to 48 carbon atoms and more preferably 6 to 24 carbon atoms; examples thereof include a phenylsulfonyl group and a 1-naphthylsulfonyl group), a sulfamoyl group (a sulfamoyl group having preferably 32 or less carbon atoms and more preferably 24 or less carbon atoms; examples thereof include a sulfamoyl group, an N,N-dipropylsulfamoyl group, an N-ethyl-N-dodecylsulfamoyl group, N-ethyl-N-phenylsulfamoyl, an N-cyclohexylsulfamoyl group, and an N-(2-ethylhexyl)sulfamoyl group), a phosphonyl group (a phosphonyl group having preferably 1 to 32 carbon atoms and more preferably 1 to 24 carbon atoms; examples thereof include a phenoxyphosphonyl group, an octyloxyphosphonyl group, and a phenylphosphonyl group), a phosphinoylamino group (a phosphinoylamino group having preferably 1 to 32 carbon atoms and more preferably 1 to 24 carbon atoms; examples thereof include a diethoxyphosphinoylamino group and a dioctyloxyphosphinoylamino group), an epoxy group, a (meth)acryloyl group, —NHCOCH₃, —SO₂NHC₂H₄OCH₃, or —NHSO₂CH₃.

[Polymer Compound]

The polymer compound according to a first aspect of the present invention (hereinafter, also simply abbreviated as “polymer compound according to the embodiment of the present invention”) is a polymer compound exhibiting liquid crystallinity, which has a repeating unit (hereinafter, also simply abbreviated as “specific repeating unit”) including, in the following order,
a rigid part consisting of a combination of an aromatic part having a 6-membered ring and an aromatic part having a 5-membered ring,
a linker part selected from Group 1,
a flexible part consisting of an alkylene group having 2 or more carbon atoms, and
a linker part selected from Group 1.
Group 1: a single bond or a divalent linking group selected from the group consisting of —O—, —S—, —CO—, —SO₂—, —CH═CH—, and a combination of these groups, where R represents a hydrogen atom or an alkyl group

However, the rigid part has a structure which consists of two or more of aromatic parts having a 6-membered ring and one or more of aromatic parts having a 5-membered ring, in which the two or more aromatic parts having a 6-membered ring are apart from each other.

In addition, in the flexible part, one or more of —CH₂-'s constituting the alkylene group other than a terminal may be substituted with —O—, —S—, —CO—, —SO₂—, —CH═CH—, or R represents a hydrogen atom or an alkyl group.

Here, “exhibiting liquid crystallinity” means that, in a case where the polymer compound alone is kept at room temperature, is heated, or is cooled after being heated, a liquid crystal state is exhibited, or that, in a case where the polymer compound alone is dissolved in a solvent, a liquid crystal state is exhibited.

In the present invention, as described above, by using the polymer compound having the specific repeating unit, it is possible to obtain a molded product having a low dielectric loss tangent.

Although the details thereof are not clear, the present inventor has presumed as follows.

That is, in the polymer compound according to the embodiment of the present invention, it is considered that the linker part (for example, —CO—O—) adjacent to the rigid part is on the same plane as the rigid part and is difficult to move, so that dielectric relaxation is less likely to occur, and as a result, it is considered that a molded product having a low dielectric loss tangent can be obtained.

Hereinafter, the specific repeating unit included in the polymer compound according to the embodiment of the present invention will be described in detail.

[Specific Repeating Unit]

As described above, the specific repeating unit included in the polymer compound according to the embodiment of the present invention is a repeating unit including a rigid part, a linker part, a flexible part, and a linker part in this order.

<Rigid Part>

The rigid part included in the specific repeating unit is a part consisting of a combination of an aromatic part having a 6-membered ring and an aromatic part having a 5-membered ring, and is a part which consists of two or more of aromatic parts having a 6-membered ring and one or more of aromatic parts having a 5-membered ring, in which the two or more aromatic parts having a 6-membered ring are apart from each other.

Here, examples of an aromatic ring constituting the above-described aromatic part having a 6-membered ring include a benzene ring, a pyridine ring, a pyridazine ring, a pyrimidine ring, a pyrazine ring, a triazine ring, and a tetrazine ring.

In addition examples of an aromatic ring constituting the above-described aromatic part having a 5-membered ring include a thiophene ring, a furan ring, a pyrrole ring, an imidazole ring, a pyrazole ring, an oxazole ring, a thiazole ring, a triazole ring, and an oxadiazole ring.

In the present invention, a fused ring including a 6-membered ring (for example, a naphthalene ring, a benzofuran ring, and the like) corresponds to the “aromatic part having a 6-membered ring”, and a fused ring including a 5-membered ring and not including a 6-membered ring (for example, a pyrrolopyrrole ring and the like) is corresponds to the “aromatic part having a 5-membered ring”.

In addition, the above-described aromatic ring may have a substituent, and this substituent may be bonded to another group to form a fused ring. Examples of the substituent include substituents described in the substituent group A above.

In the present invention, from the reason that a molded product having a lower dielectric loss tangent can be obtained, the above-described aromatic part having a 6-membered ring is preferably a structure represented by Formula (1) or (2), and from the reason that a molded product having a further lower dielectric loss tangent can be obtained, it is more preferable to be a structure represented by Formula (2).

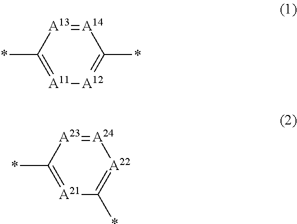

In Formulae (1) and (2), * represents a bonding position.

In Formula (1), A¹¹, A¹², A¹³, and A¹⁴ each independently represent a methine or a nitrogen atom.

In Formula (2), A²¹, A²², A²³, and A²⁴ each independently represent a methine or a nitrogen atom.

Examples of the above-described structure represented by Formula (1) include a 1,4-phenylene group, a pyridine-2,5-diyl group, and a pyrazine-2,5-diyl group.

Examples of the above-described structure represented by Formula (2) include a 1,3-phenylene group, a pyridine-2,6-diyl group, and a pyrazine-2,6-diyl group.

In the present invention, from the reason that a molded product having a lower dielectric loss tangent can be obtained, the above-described aromatic part having a 5-membered ring is preferably a structure represented by Formula (3) or (4), and from the reason of ease of synthesis, it is more preferable to be a structure represented by Formula (4).

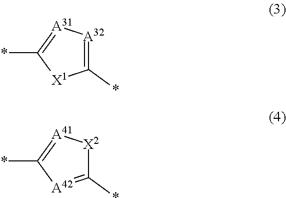

In Formulae (3) and (4), * represents a bonding position.

In Formula (3), A³¹ and A³² each independently represent a methine or a nitrogen atom.

In Formula (3), X¹ represents an oxygen atom, a sulfur atom, or —NR. R represents a hydrogen atom or an alkyl group.

In Formula (4), A⁴¹ and A⁴² each independently represent a methine or a nitrogen atom.

In Formula (4), X² represents an oxygen atom, a sulfur atom, or —NR. R represents a hydrogen atom or an alkyl group.

Examples of the above-described structure represented by Formula (3) include a thiophene-2,5-diyl group, a furan-2,5-diyl group, an oxazole-2,5-diyl group, and a 1,3,4-oxadiazole-2,5-diyl group.

Examples of the above-described structure represented by Formula (4) include a thiophene-2,4-diyl group, a furan-2,4-diyl group, an oxazole-2,4-diyl group, and a 1,2,4-oxadiazole-3,5-diyl group.

The rigid part included in the specific repeating unit can be synthesized, for example, by referring to a synthesis method of a compound represented by General Formula (1) or (la) described in JP2010-244038A.

<Linker Part>

The linker part included in the specific repeating unit is a part selected from Group 1.

Group 1: a single bond or a divalent linking group selected from the group consisting of —O—, —S—, —CO—, —SO₂—, —NR—, —CH═CH—, and a combination of these groups, where R represents a hydrogen atom or an alkyl group

Specific examples of the divalent linking group in the group 1 include —O—, —S—, —CO—, —CO—O—, —CH═CH—, —SO₂—O—, and —CO—NR²—. R¹ and R² represent a hydrogen atom or an alkyl group having 1 to 12 carbon atoms.

In the present invention, from the reason that a molded product having a lower dielectric loss tangent can be obtained, the linker part is preferably any of a single bond, *—CO—O—, or *—CO—NR²—. * represents a bonding position with the rigid part.

<Flexible Part>

The flexible part included in the specific repeating unit is a part consisting of an alkylene group having 2 or more carbon atoms, in which one or more of —CH₂-'s constituting the alkylene group other than a terminal may be substituted with —O—, —S—, —CO—, —SO₂—, —NR—, —CH═CH—, or R represents a hydrogen atom or an alkyl group.

Examples of the alkylene group having 2 or more carbon atoms include a linear, branched, or cyclic alkylene group having 2 to 12 carbon atoms, and specifically, suitable examples thereof include an ethylene group, a propylene group, a butylene group, a pentylene group, a hexylene group, a methylhexylene group, a heptylene group, and a cyclohexane-1,4-diyl group.

[Other Repeating Units]

The polymer compound according to the embodiment of the present invention is not particularly limited as long as it is a polymer having the above-described specific repeating unit and exhibiting liquid crystallinity, and the polymer compound according to the embodiment of the present invention may have other repeating units in addition to the above-described specific repeating unit.

In a case where the polymer compound according to the embodiment of the present invention has other repeating units, a content of the specific repeating unit is, in mol ratio, preferably 80 mol % or more, more preferably 85 mol % or more, and still more preferably 90 to 99 mol %.

[Molecular Weight]

A weight-average molecular weight (Mw) of the polymer compound according to the embodiment of the present invention is not particularly limited, but from the reason of ease of handling, it is preferably 1,000 to 500,000 and more preferably 2,000 to 300,000.

Here, the weight-average molecular weight can be measured, for example, by a gel permeation chromatograph (GPC) method.

[Liquid Crystallinity]

A liquid crystal phase exhibited by the polymer compound according to the embodiment of the present invention may be any of a nematic phase, a discotic nematic phase, a smectic phase, or a columnar phase, but the polymer compound according to the embodiment of the present invention preferably exhibits at least a nematic phase or a discotic nematic phase.

A temperature range for exhibiting the liquid crystal phase is preferably 0° C. to 450° C., and from the viewpoint of handling and production suitability, 30° C. to 400° C. is preferable.

The polymer compound according to a second aspect of the present invention is a polymer compound having a repeating unit including, in the following order,
a rigid part consisting of a combination of an aromatic part having a 6-membered ring and an aromatic part having a 5-membered ring,
a linker part selected from Group 1,
a flexible part consisting of an alkylene group having 2 or more carbon atoms, and
a linker part selected from Group 1,
in which the aromatic part having a 6-membered ring is a 1,3-phenylene group or a 1,4-phenylene group, and
the aromatic part having a 5-membered ring is a 1,2,4-oxadiazole-3,5-diyl group.
Group 1: a single bond or a divalent linking group selected from the group consisting of —O—, —S—, —CO—, —SO₂—, —NR—, —CH═CH—, and a combination of these groups, where R represents a hydrogen atom or an alkyl group

However, the rigid part has a structure which consists of two or more of the aromatic parts having a 6-membered ring and one or more of the aromatic parts having a 5-membered ring, in which the two or more aromatic parts having a 6-membered ring are apart from each other.

In addition, in the flexible part, one or more of —CH₂-'s constituting the alkylene group other than a terminal may be substituted with —O—, —S—, —CO—, —SO₂—, —NR—, —CH═CH—, or R represents a hydrogen atom or an alkyl group.

That is, the polymer compound according to the second aspect of the present invention is a polymer that, with regard to the rigid part included in the specific repeating unit in the above-described polymer compound according to the first aspect of the present invention, the aromatic part having a 6-membered ring is limited to a 1,3-phenylene group or a 1,4-phenylene group, and the aromatic part having a 5-membered ring is limited to a 1,2,4-oxadiazole-3,5-diyl group.

In addition, the polymer compound according to the second aspect of the present invention is a polymer that is not limited to the requirement of “exhibiting liquid crystallinity” defined in the above-described polymer compound according to the first aspect of the present invention. It is preferable that the polymer compound according to the second aspect of the present invention is a polymer compound exhibiting liquid crystallinity, as in the above-described polymer compound according to the first aspect of the present invention.

[Production Method]

A method for producing the polymer compounds according to the first aspect and the second aspect of the present invention is not particularly limited, and the polymer compound can be obtained by subjecting a polymerizable monomer to a known polycondensation method (for example, a melting acidlysis method, a slurry polymerization method, and the like) for forming an ester bond or an amide bond.

Examples of the production method are shown in the following formulae. In the formulae, Rig represents a rigid part and Fle represents a flexible part.

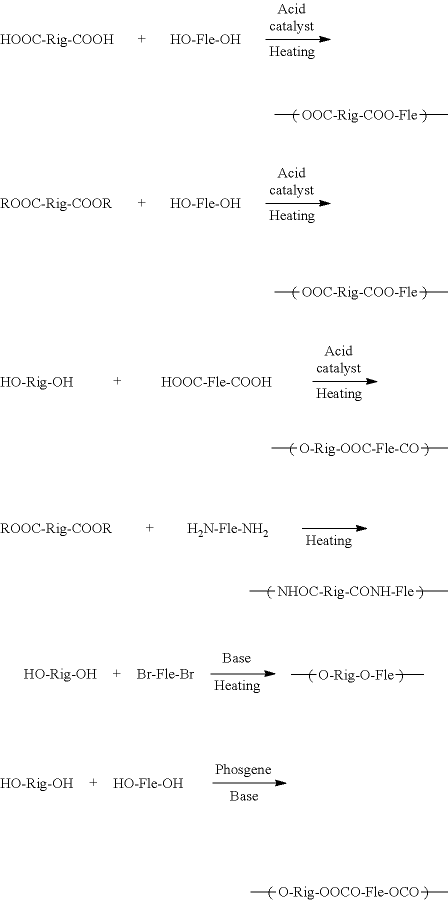

Specific examples of the polymer compounds according to the first aspect and the second aspect of the present invention are shown below.

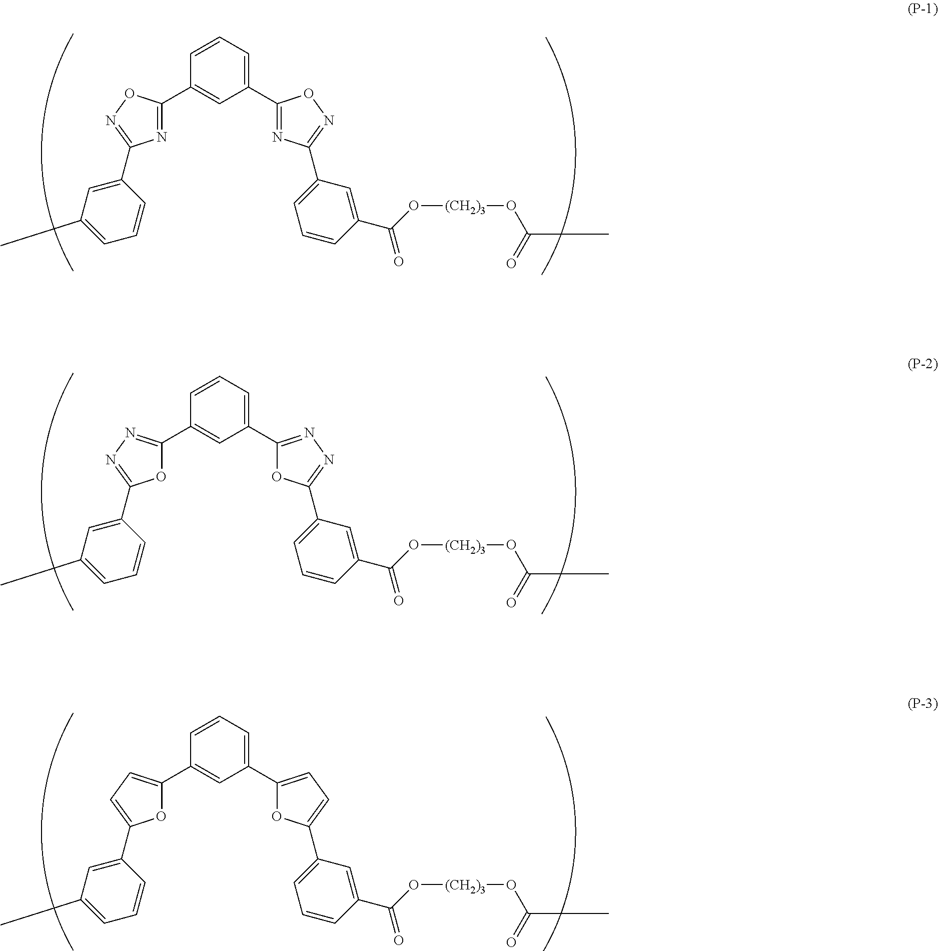

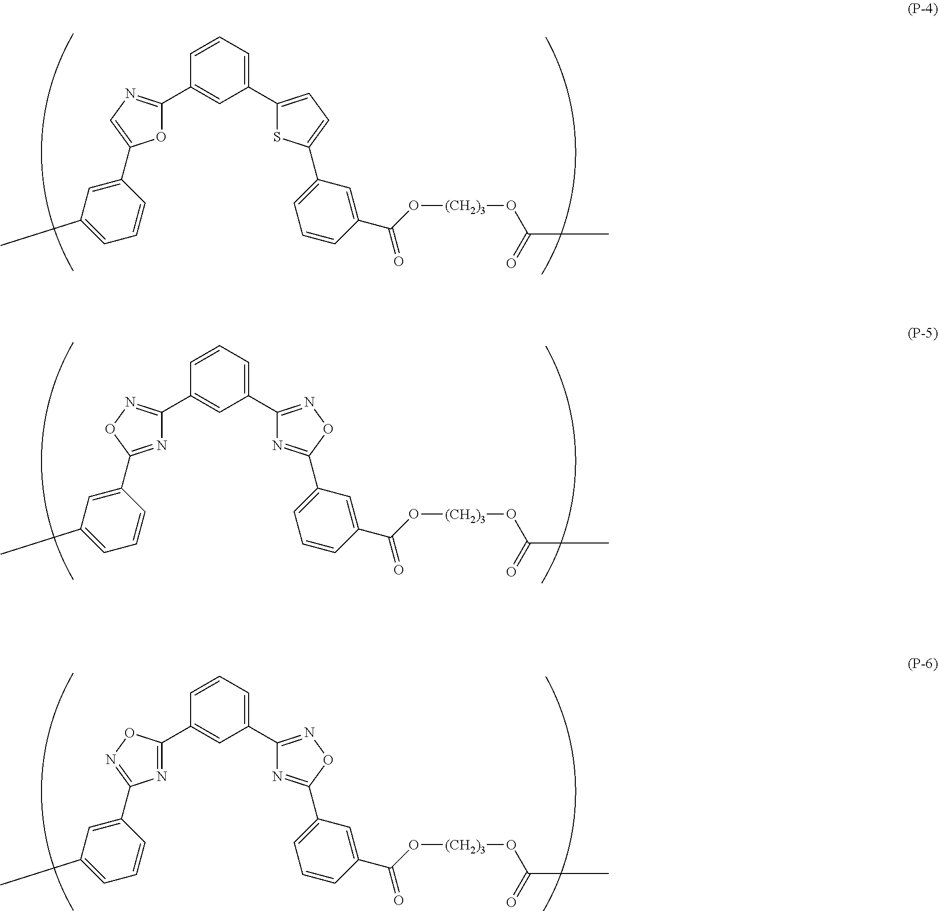

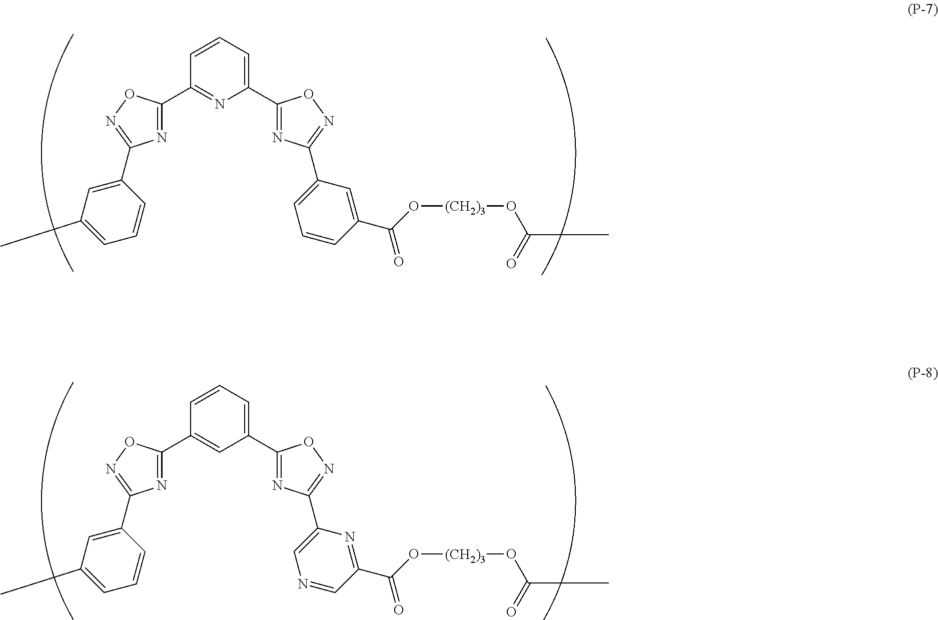

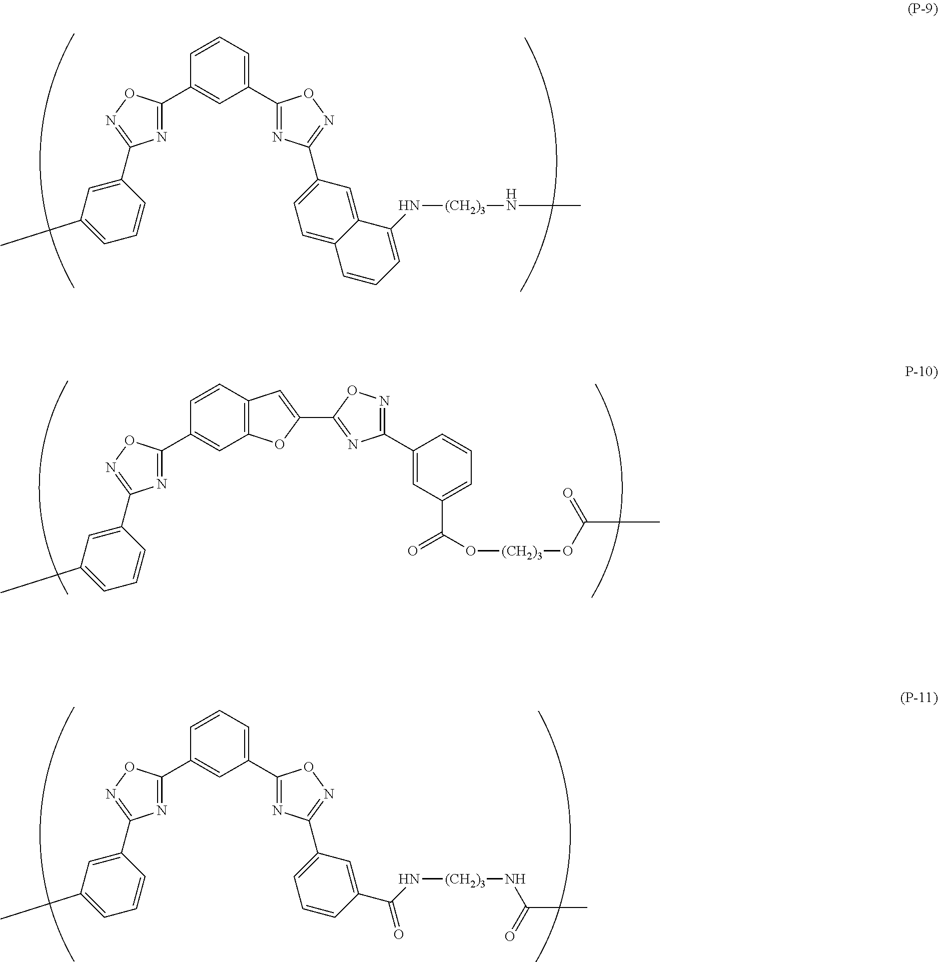

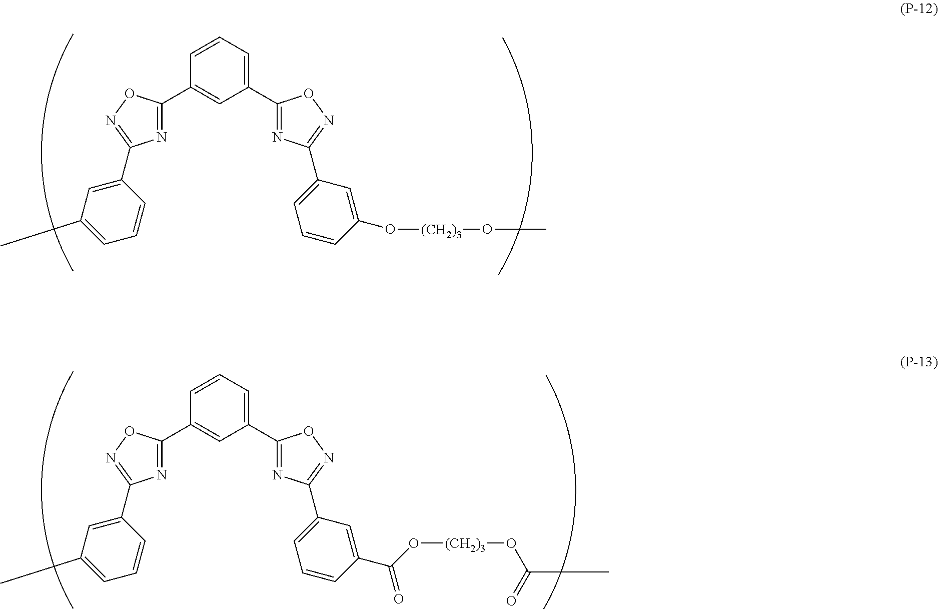

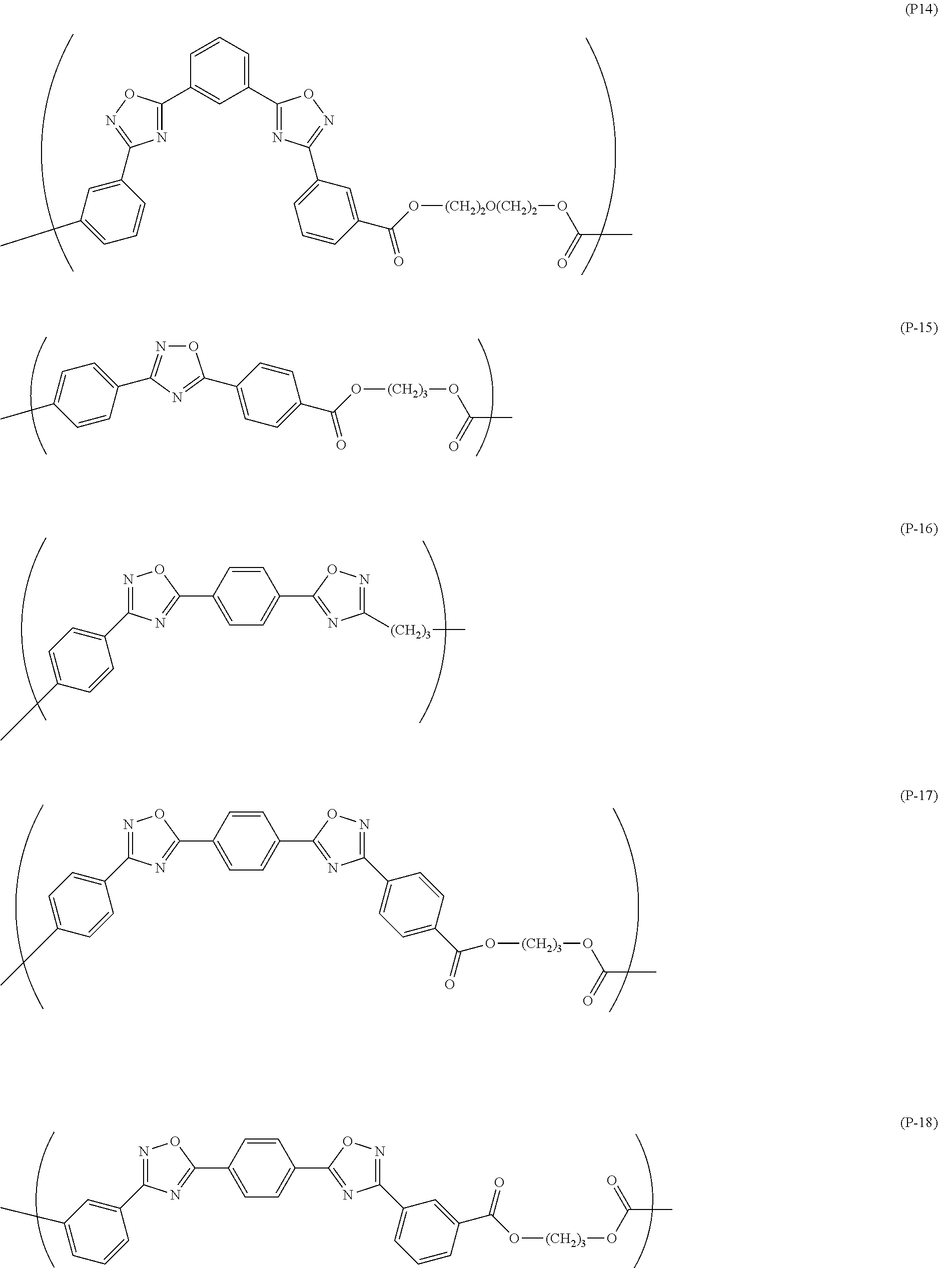

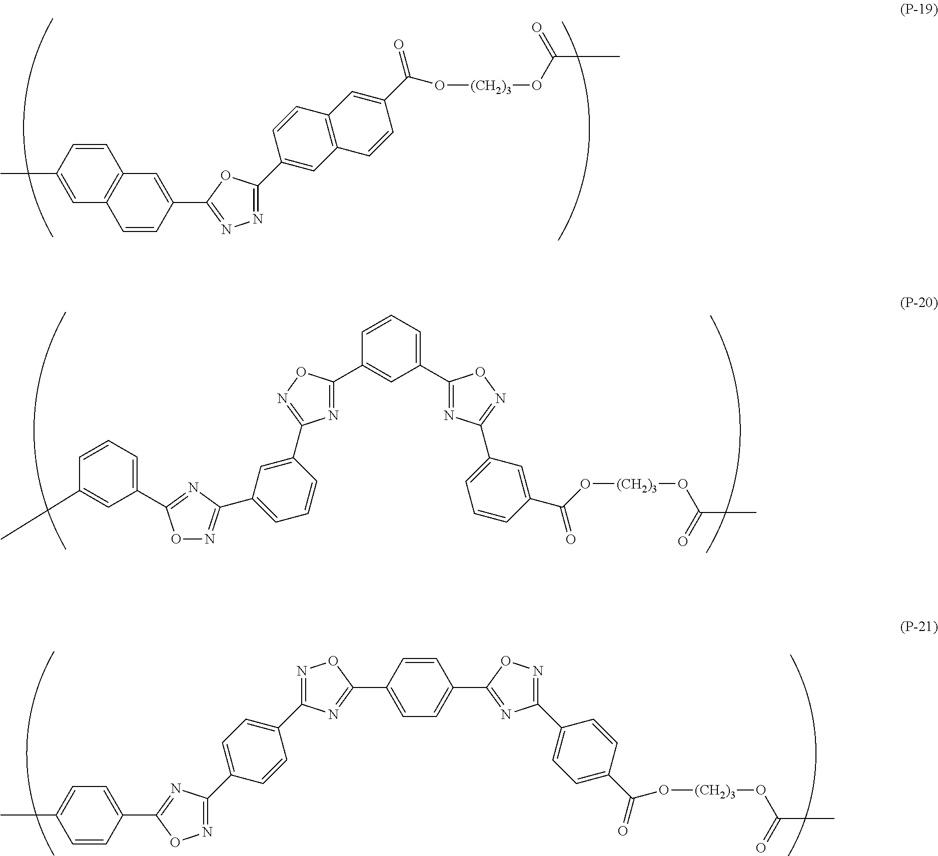

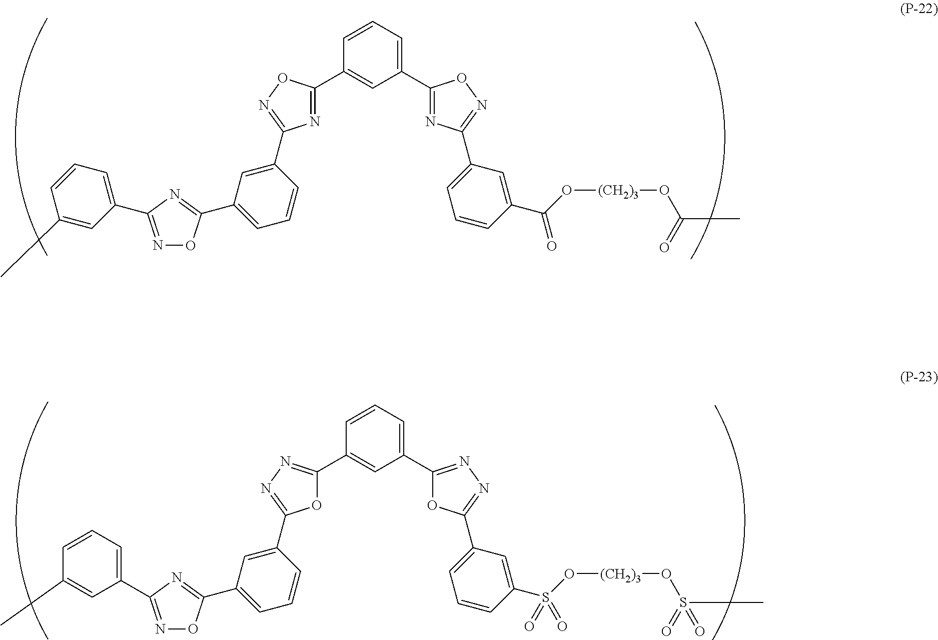

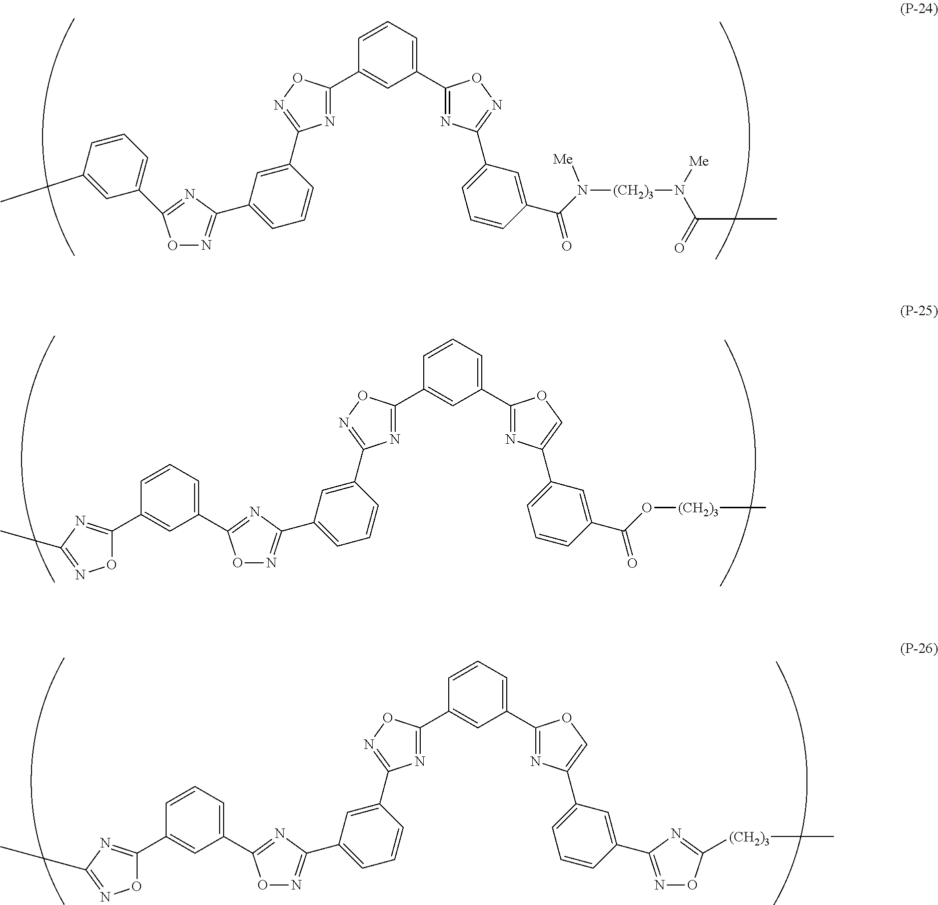

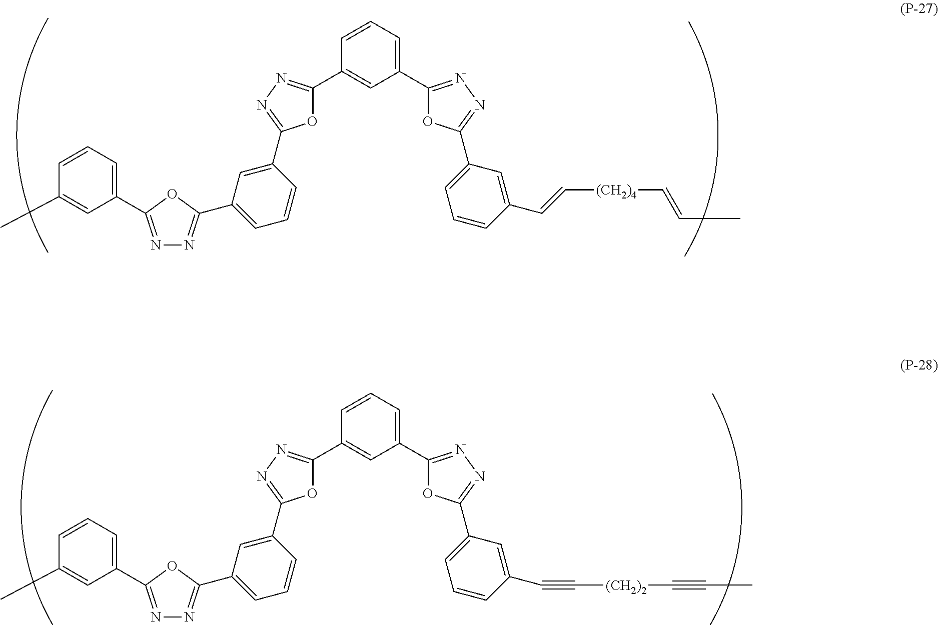

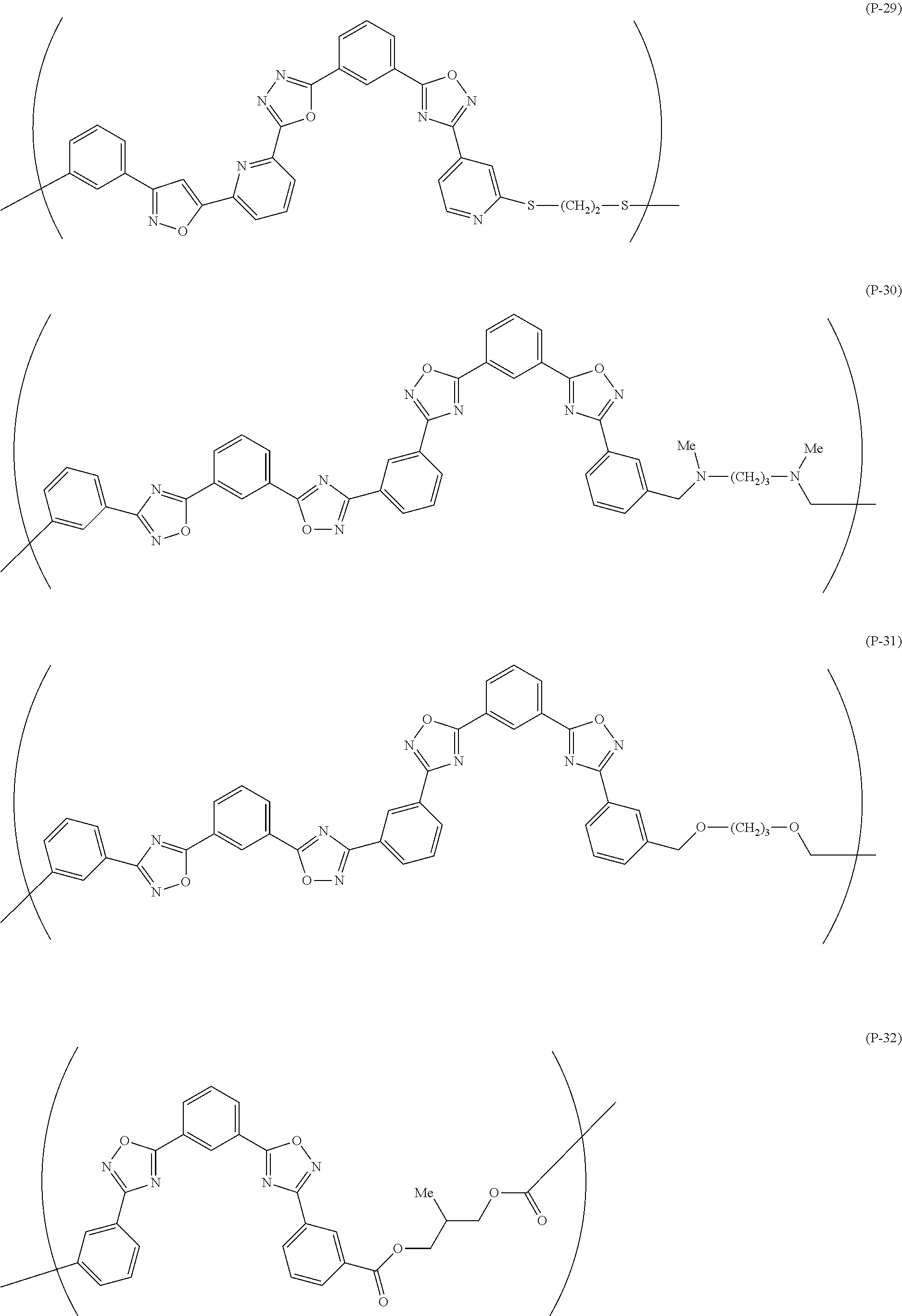

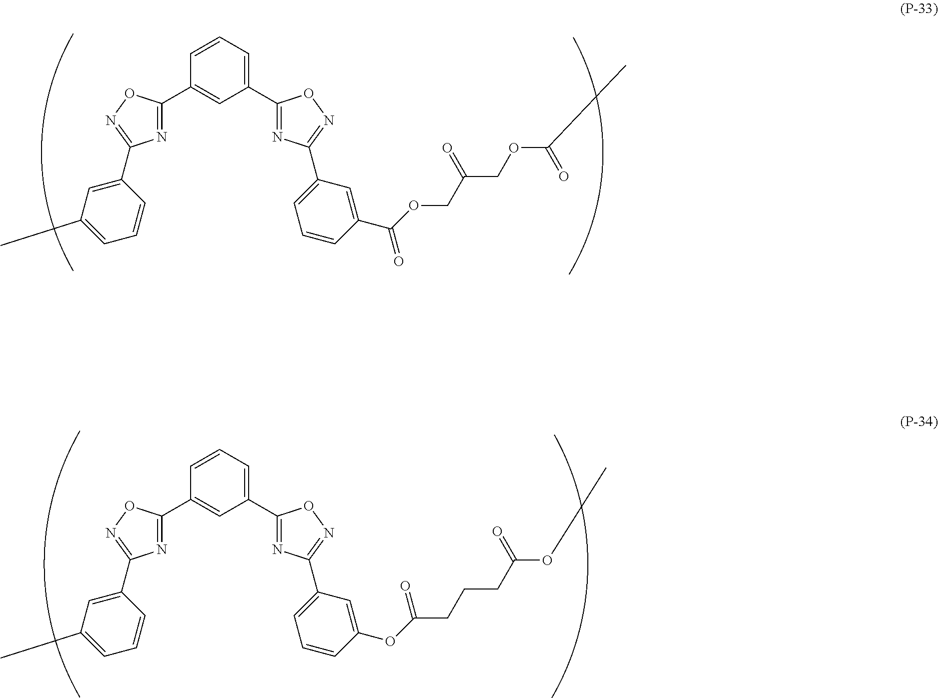

[Composition]

The composition according to the embodiment of the present invention is a composition containing the above-described polymer compound according to the first aspect or the second aspect of the present invention.

Here, a content of the polymer compound is preferably 10% to 97% by mass, more preferably 40% to 95% by mass, and still more preferably 60% to 95% by mass with respect to the total solid content (100% by mass) of the composition.

[Resin Component]

The composition according to the embodiment of the present invention preferably contains a resin component.

Examples of the resin component include an epoxy resin, a polyacrylate resin, a phenol resin, and a polyimide resin, and among these, it is preferable to contain an epoxy resin or a polyacrylate resin.

Specific examples of the epoxy resin include a bixylenol epoxy resin, a bisphenol A epoxy resin, a bisphenol F epoxy resin, a bisphenol S epoxy resin, a bisphenol AF epoxy resin, a dicyclopentadiene epoxy resin, a trisphenol epoxy resin, a naphthol novolak epoxy resin, a phenol novolak epoxy resin, a tert-butyl-catechol epoxy resin, a naphthalene epoxy resin, a naphthol epoxy resin, an anthracene epoxy resin, a glycidylamine epoxy resin, a glycidyl ester epoxy resin, a cresol novolak epoxy resin, a biphenyl epoxy resin, a linear aliphatic epoxy resin, an epoxy resin having a butadiene structure, an alicyclic epoxy resin, a heterocyclic epoxy resin, an epoxy resin containing a spiro ring, a cyclohexanedimethanol epoxy resin, a naphthylene ether epoxy resin, a trimethylol epoxy resin, a tetraphenylethane epoxy resin, and a halogenated epoxy resin.

The polyarylate resin is a resin containing an aromatic dicarboxylic acid or a derivative thereof and a divalent phenol or a derivative thereof as a constitutional unit, and can be produced by a method such as a solution polymerization, a melt polymerization, and an interfacial polymerization.

Examples of the aromatic dicarboxylic acid constituting the polyarylate resin include terephthalic acid and isophthalic acid, and from the viewpoint of melt processability and overall performance, a mixture of both is preferable. A formulating ratio of the terephthalic acid and the isophthalic acid in the mixture is not limited, but a mass ratio thereof is preferably terephthalic acid/isophthalic acid=9/1 to 1/9. In consideration of a balance between melt processability and performance, the formulating ratio is preferably 7/3 to 3/7, and particularly preferably 1/1.

As the divalent phenol constituting the polyarylate resin include 2,2-bis(4-hydroxyphenyl)propane, 2,2-bis(4-hydroxy-3,5-dibromophenyl)propane, 2,2-bis(4-hydroxy-3,5-dichlorophenyl)propane, 4,4′-dihydroxydiphenyl sulfone, 4,4′-dihydrodiphenyl ether, 4,4′-dihydroxydiphenyl sulfide, 4,4′-dihydroxydiphenyl ketone, 4,4′-dihydroxydiphenyl methane, 2,2-bis(4-hydroxy-3,5-dimethylphenyl)propane, 1,1-bis(4-hydroxyphenyl)ethane, 1,1-bis(4-hydroxyphenyl)cyclohexane, 4,4′-dihydroxydiphenyl, and hydroquinone, and 2,2-bis(4-hydroxyphenyl)propane [bisphenol A] is preferable. These may be used alone, or may be used as a mixture thereof. Furthermore, a small amount of ethylene glycol, propylene glycol, or the like may be used in combination with these divalent phenols.

[Curing Agent]

In a case where the composition according to the embodiment of the present invention contains the epoxy resin, it is preferable to contain a curing agent together with the epoxy resin.

The above-described curing agent is not particularly limited, and examples thereof include a phenol-based curing agent, a naphthol-based curing agent, an active ester-based curing agent, a benzoxazine-based curing agent, a cyanate ester-based curing agent, and a carbodiimide-based curing agent.

One kind of the curing agent may be used alone, or two or more kinds of the curing agents may be used in combination at any ratio.

[Filling Material]

The composition according to the embodiment of the present invention may contain a filling material.

The filling material is not particularly limited, and examples thereof include silica, alumina, glass, cordierite, silicon oxide, barium sulfate, barium carbonate, talc, clay, mica powder, zinc oxide, hydrotalcite, boehmite, aluminum hydroxide, magnesium hydroxide, calcium carbonate, magnesium carbonate, magnesium oxide, boron nitride, aluminum nitride, manganese nitride, aluminum borate, strontium carbonate, barium titanate, strontium titanate, calcium titanate, magnesium titanate, bismuth titanate, titanium oxide, zirconium oxide, barium zirconate titanate, barium zirconate, calcium zirconate, zirconium phosphate, and zirconium phosphate tungstate.

One kind of the filling material may be used alone, or two or more kinds of the filling materials may be used in combination at any ratio.

[Other Additives]

The composition according to the embodiment of the present invention may contain other additives such as a flame retardant; an organic filling material; an organic metal compound such as an organic copper compound, an organic zinc compound, and an organic cobalt compound; a viscosity improver; a defoamer; a leveling agent; an adhesion-imparting agent; and a colorant.

The composition according to the embodiment of the present invention can provide a cured substance having a low dielectric loss tangent and good adhesiveness to a conductor layer.

Therefore, the composition according to the embodiment of the present invention can be suitably used as a resin composition for forming an insulating layer of a printed wiring board (resin composition for an insulating layer of a printed wiring board), and can be more suitably used as a resin composition for forming an interlayer insulation layer of a printed wiring board (resin composition for an interlayer insulation layer of a printed wiring board).

In addition, the composition according to the embodiment of the present invention can be used in a wide variety of applications where a resin composition is required, such as sheet laminate materials such as an adhesive film and a prepreg, solder resists, underfill materials, die bonding materials, semiconductor sealing materials, hole filling resins, and component embedding resins.

A method for preparing the composition according to the embodiment of the present invention is not particularly limited, and examples thereof include a method in which a solvent or the like is added to formulation components as necessary, and the mixture is mixed and dispersed using a rotary mixer or the like.

[Molded Product]

The molded product according to the embodiment of the present invention is a molded product obtained by processing the above-described polymer compound according to the first aspect or the second aspect of the present invention, or the above-described composition according to the embodiment of the present invention.

Examples of such a molded product include a molded article formed in each application of the composition according to the embodiment of the present invention described above.

### EXAMPLES

Hereinafter, the present invention will be described in more detail with reference to Examples. The materials, amounts used, proportions, treatment details, treatment procedures, and the like described in the following examples can be appropriately modified as long as the gist of the present invention is maintained. Therefore, the scope of the present invention should not be construed as being limited by the following examples.

### Example 1

The following rigid monomer 1 was synthesized with reference to Comparative Example 1 of JP2010-244038A.

The obtained rigid monomer 1 (5 g) was mixed with equimolar propanediol, 0.1% by mass of paratoluenesulfonic acid was added thereto under a nitrogen atmosphere, and the mixture was heated at 250° C. for 3 hours and then heated at 250° C. for 10 hours under reduced pressure to obtain the following LCP1 as a target product.

It was confirmed that the obtained LCP1 exhibited liquid crystallinity with a polarization microscope.

In addition, the obtained LCP1 was melt-formed to produce a film having a film thickness of 100 μm.

A dielectric loss tangent (25° C., 15 GHz) of the produced film was 0.0005.

Rigid Monomer 1

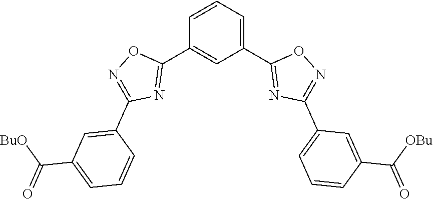

LCP1

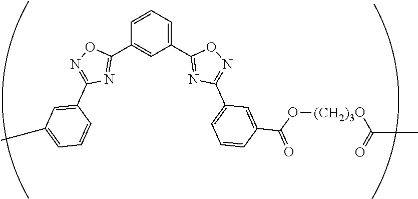

### Comparative Example 1

The following acrylate monomer A was synthesized with reference to Example 1 of JP2007-204705A.

Acrylate Monomer A

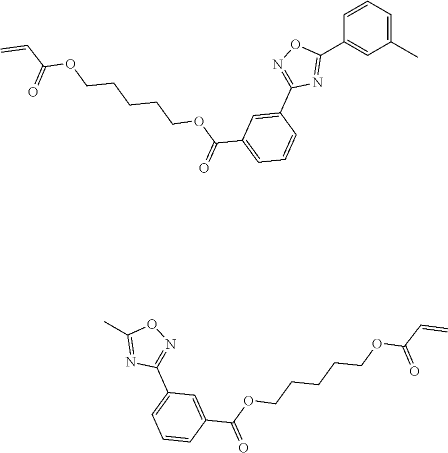

0.1% by mass of a polymerization initiator IRGACURE 819 (manufactured by BASF) was added to the obtained acrylate monomer (20 g), and the mixture was heated to 90° C. and kneaded.

The obtained mixture was melt-formed at 90° C. to a film thickness of 100 cooled to 72° C., and irradiated with ultraviolet rays having a wavelength of 365 nm (5 J) under a nitrogen atmosphere to produce a film.

A dielectric loss tangent (25° C., 15 GHz) of the produced film was 0.01.

What is claimed is:

1. A polymer compound exhibiting liquid crystallinity, comprising:
a repeating unit including, in the following order,
a rigid part consisting of a combination of an aromatic part having a 6-membered ring and an aromatic part having a 5-membered ring,
a linker part selected from Group 1,
a flexible part consisting of an alkylene group having 2 or more carbon atoms, and
a linker part selected from Group 1, Group 1: a single bond or a divalent linking group selected from the group consisting of —O—, —S—, —CO—, —SO₂—, —NR—, —CH═CH—, —C≡C—, and a combination of these groups, where R represents a hydrogen atom or an alkyl group,
provided that the rigid part has a structure which consists of two or more of aromatic parts having a 6-membered ring and one or more of aromatic parts having a 5-membered ring, where the two or more aromatic parts having a 6-membered ring are apart from each other, and
in the flexible part, one or more of —CH₂-'s constituting the alkylene group other than a terminal may be substituted with —O—, —S—, —CO—, —SO₂—, —NR—, —CH═CH—, or —C≡C—, where R represents a hydrogen atom or an alkyl group.

2. The polymer compound according to claim 1,
wherein the aromatic part having a 6-membered ring is represented by Formula (1) or (2), 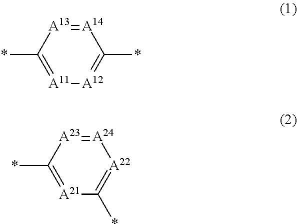
in Formulae (1) and (2),
* represents a bonding position,
A¹¹, A¹², A¹³, and A¹⁴ each independently represent a methine or a nitrogen atom, and
A²¹, A²², A²³, and A²⁴ each independently represent a methine or a nitrogen atom.

3. The polymer compound according to claim 1,
wherein the aromatic part having a 5-membered ring is represented by Formula (3) or (4), 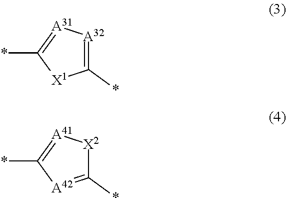
in Formulae (3) and (4),
* represents a bonding position,
A³¹ and A³² each independently represent a methine or a nitrogen atom,
X¹ represents an oxygen atom, a sulfur atom, or —NR, where R represents a hydrogen atom or an alkyl group,
A⁴¹ and A⁴² each independently represent a methine or a nitrogen atom, and
X² represents an oxygen atom, a sulfur atom, or —NR, where R represents a hydrogen atom or an alkyl group.

4. The polymer compound according to claim 2,
wherein the aromatic part having a 5-membered ring is represented by Formula (3) or (4), 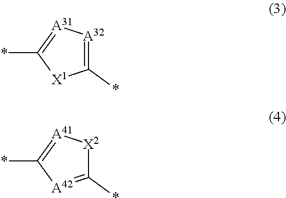
in Formulae (3) and (4),
* represents a bonding position,
A³¹ and A³² each independently represent a methine or a nitrogen atom,
X¹ represents an oxygen atom, a sulfur atom, or —NR, where R represents a hydrogen atom or an alkyl group,
A⁴¹ and A⁴² each independently represent a methine or a nitrogen atom, and
X² represents an oxygen atom, a sulfur atom, or —NR, where R represents a hydrogen atom or an alkyl group.

5. A polymer compound comprising:
a repeating unit including, in the following order,
a rigid part consisting of a combination of an aromatic part having a 6-membered ring and an aromatic part having a 5-membered ring,
a linker part selected from Group 1,
a flexible part consisting of an alkylene group having 2 or more carbon atoms, and
a linker part selected from Group 1,
wherein the aromatic part having a 6-membered ring is a 1,3-phenylene group or a 1,4-phenylene group,
the aromatic part having a 5-membered ring is a 1,2,4-oxadiazole-3,5-diyl group,
Group 1: a single bond or a divalent linking group selected from the group consisting of —O—, —S—, —CO—, —SO₂—, —NR—, —CH═CH—, and a combination of these groups, where R represents a hydrogen atom or an alkyl group,
provided that the rigid part has a structure which consists of two or more of aromatic parts having a 6-membered ring and one or more of aromatic parts having a 5-membered ring, where the two or more aromatic parts having a 6-membered ring are apart from each other, and
in the flexible part, one or more of —CH₂-'s constituting the alkylene group other than a terminal may be substituted with —O—, —S—, —CO—, —SO₂—, —NR—, —CH═CH—, or where R represents a hydrogen atom or an alkyl group.

6. The polymer compound according to claim 5,
wherein the aromatic part having a 6-membered ring is a 1,3-phenylene group.

7. A composition comprising:
the polymer compound according to claim 1.

8. A composition comprising:
the polymer compound according to claim 5.

9. A composition comprising:
the polymer compound according to claim 6.

10. A molded product obtained by processing the composition according to claim 7.

11. A molded product obtained by processing the composition according to claim 8.

12. A molded product obtained by processing the composition according to claim 9.
